(19) United States
(12) Patent Application Publication
(10) Pub. No.: US 2010/0282660 A1
(43) Pub. Date: Nov. 11, 2010

(54) CARTRIDGE FILTER SECURING APPARATUS

(76) Inventor: C. Michael Hughes, Kenton, OH (US)

Correspondence Address: BENESCH, FRIEDLANDER, COPLAN & ARONOFF LLP;ATTN: IP DEPARTMENT DOCKET CLERK, 200 PUBLIC SQUARE, SUITE 2300, CLEVELAND, OH, 44114-2378, US

(21) Appl. No.: 12/775,760

(22) Filed: May 7, 2010

Related U.S. Application Data
(60) Provisional application No. 61/176,371, filed on May 7, 2009.

(51) Int. Cl. B01D 35/30

(52) U.S. Cl. 210/237; 210/232

(57) ABSTRACT

Methods, apparatuses, and systems are provided for securing a cartridge filter.

### CROSS REFERENCE TO RELATED APPLICATION

This application claims the benefit of priority of U.S. Provisional Application No. 61/176,371, filed on May 7, 2009 which is hereby incorporated by reference in its entirety.

### BACKGROUND

Cartridge filters are used to filter debris and contaminants from water in pool and spa filtration systems. Cartridge filters are also used in vacuum cleaners to collect debris in vacuum cleaning units. Internal combustion and diesel engines also use cartridge filters to filter air before it enters the engine's air intake. Cartridge filters are also used in various other applications to filter or collect debris. As cartridge filters accumulate debris and contaminants, their functionality becomes limited. This may result in systems requiring additional energy to operate effectively and is, thus, a source of inefficiency.

Current cartridges may be periodically cleaned of debris and contaminants. However, cleaning of cartridge filters can be difficult. Cartridge filters often include multiple ribs extending radially outwardly from the filter, each of which requires cleaning of both surfaces as well as the crevice formed between it and the adjacent rib.

### SUMMARY

In one embodiment, an apparatus includes a first mounting member, a second mounting member, a first filter support device, a second filter support device, and an elongated shaft. At least a portion of the filter support devices is configured to selectively engage at least a first and second end portion of a cartridge filter. At least a portion of the elongated shaft is operatively connected to the second mounting member, the second filter support device, and a handle.

In another embodiment, an apparatus for securing a filter includes at least a first mounting member, a second mounting member, a first filter support device, a second filter support device, and an elongated shaft. At least a portion of the elongated shaft is operatively connected to the second mounting member, the second filter support device, and a handle.

In another embodiment, an apparatus includes a first mounting member, a first filter support device, a second filter support device, an elongated shaft, and at least one filter support retention device. At least a portion of the elongated shaft is operatively connected to the first mounting member by a joint device, and is also operatively connected the filter support devices. The at least one filter support retention device is configured to selectively engage the elongated shaft with the second filter support device, thereby preventing substantial displacement of one relative to the other.

In another embodiment, an apparatus includes at least a first mounting member and a second mounting member. The apparatus also includes an elongated shaft and a joint device operatively connecting the elongated shaft to the first mounting member. The apparatus further has a first filter support device and a second filter support device, each operatively connected to the elongated shaft, wherein the first filter support device and the second filter support device are configured to rotate about an axis substantially parallel to the elongated shaft. At least one of the first filter support device and second filter support device are constrained to rotate in a single direction.

### BRIEF DESCRIPTION OF THE DRAWINGS

The accompanying figures, which are incorporated in and constitute a part of the specification, illustrate various example apparatuses, systems, methods, and so on, and are used merely to illustrate various example embodiments. It should be noted that various components depicted in the figures may not be drawn to scale, and that the various assemblies and designs depicted in the figures are presented for purposes of illustration only, and should not be considered in any way as limiting.

FIG. 1 is a side view of one embodiment of an apparatus for securing a filter.

FIG. 2 is a side view of one embodiment of the apparatus for securing a filter in an open position.

FIG. 3 is a side view of an alternative embodiment of an apparatus for securing a filter.

FIG. 4 is a side view of another alternative embodiment of an apparatus for securing a filter.

FIG. 5a is a top view of another alternative embodiment of an apparatus for securing a filter.

FIG. 5b is a side view of another alternative embodiment of an apparatus for securing a filter.

FIG. 6 is a side view of another alternative embodiment of an apparatus for securing a filter.

### DETAILED DESCRIPTION

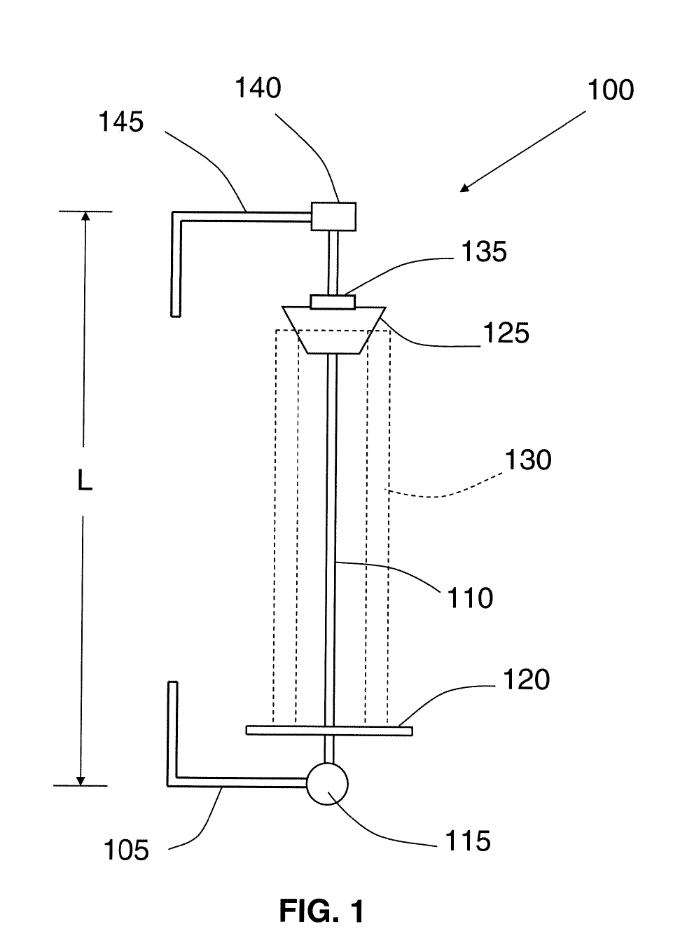

FIG. 1 illustrates one embodiment of an apparatus 100 for securing a filter. Apparatus 100 includes a first mounting member 105 and an elongated shaft 110. The elongated shaft 110 is operatively connected to first mounting member 105 by a joint device 115. A first filter support device 120 and second filter support device 125 are operatively connected to elongated shaft 110, such that a cartridge filter 130 (shown in phantom) may be disposed therebetween. First mounting member 105 may be of any arrangement sufficient to provide a stable mounting base to which elongated shaft 110 is operatively connected. First mounting member 105 may be configured to allow for mechanical attachment of first mounting member 105 to another structure (e.g., a wall, a pole, a fence post, or a vehicle).

Elongated shaft 110 is a bar or tube of any cross-sectional shape. In one embodiment, at least a portion of elongated shaft 110 includes one or more threads, substantially transverse ribs, or indentations. In another embodiment, at least a portion of elongated shaft 110 includes substantially transverse perforations, including, but not limited to, substantially transverse holes extending at least partially across the diameter of elongated shaft 110. In one embodiment, at least the portion of the elongated shaft configured to engage a first filter support device includes one or more threads, substantially transverse ribs, indentations, or substantially transverse perforations. In another embodiment, at least the portion of the elongated shaft configured to engage a second filter support device includes one or more threads, substantially transverse ribs, indentations, or substantially transverse perforations. In another embodiment, at least the portion of the elongated shaft configured to engage an elongated shaft retention device includes one or more threads, substantially transverse ribs, indentations, or substantially transverse perforations.

In one embodiment, joint device 115 permits angular displacement of elongated shaft 110 about at least one axis substantially transverse to elongated shaft 110. In this embodiment, one of ordinary skill will recognize that joint device 115 may be a hinge, a ball and socket, or any other device capable of allowing angular displacement of elongated shaft 110. In another embodiment, joint device 115 permits translational displacement of elongated shaft 110 relative to first mounting member 105. In such an embodiment, joint device 115 may provide for translational displacement of elongated shaft 110 in the longitudinal direction, transverse direction, or both. In such an embodiment, one of ordinary skill will readily recognize that one or more slides may be used to facilitate the desired displacement.

In yet another embodiment, joint device 115 permits both angular displacement and translational displacement of elongated shaft 110. In still another embodiment, joint device 115 is configured to permit one or both of angular displacement and translational displacement of elongated shaft 110, but prevents rotation of elongated shaft 110 about an axis substantially parallel to the elongated shaft. Joint device 115 may also include a locking mechanism (not shown), by which joint device 115 is, in one mode, selectively configured to provide displacement in a first angular or linear direction, and in another mode, selectively configured to prevent displacement in a second angular or linear direction.

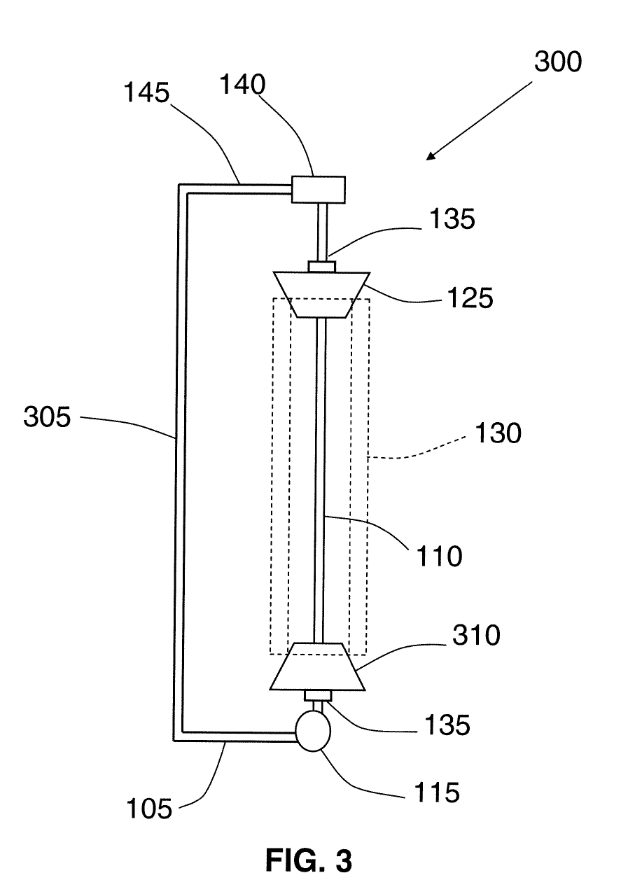

First filter support device 120 and second filter support device 125 may be of one or more of any beneficial shapes, as will be readily recognized by one of ordinary skill. In the illustrated embodiment first filter support device 120 includes a substantially flat surface that extends transversely from elongated shaft 110 and engages an end surface of cartridge filter 130 when installed. Second filter support device 125 tapers from one end to another, and selectively engages an inner circumference of the cartridge filter. The tapered shape of the second filter support device includes, without limitation, a frustum, a sphere, and a hemisphere, and any other shape that can be oriented so as to extend at least partially into the interior of cartridge filter 130. In an alternative embodiment (not shown), both the first and second filter support devices are substantially flat. In another alternative embodiment (such as that shown in FIG. 3), both the first and second filter support devices are tapered.

In another embodiment, at least a portion of one or both filter support devices 120, 125 may be threaded to engage a cartridge filter 130 having threads. In one embodiment, as illustrated in FIG. 1, the filter support devices 120, 125 may be coaxial with elongated shaft 110. In another embodiment, only one of the filter support devices 120, 125 may be coaxial with the elongated shaft 110.

In one embodiment, first filter support device 120 is fixed to elongated shaft 110 so as to prevent movement of the first filter support device relative to the elongated shaft. In an alternative embodiment, first filter support device 120 is integral with elongated shaft 110. In another alternative embodiment, first filter support device 120 is removably attached to elongated shaft 110. In yet another embodiment, one or both of filter support devices 120, 125 is capable of rotational movement about an axis substantially parallel to elongated shaft 110. In another embodiment, one or both of filter support devices 120, 125 is capable of both longitudinal translation along elongated shaft 110 and rotational translation about an axis substantially parallel to elongated shaft 110.

In one known embodiment, the second filter support device 125 is configured to translate in an axial direction along the elongated shaft 110. As depicted in FIG. 1, apparatus 100 further includes a filter support retention device 135 configured to selectively engage elongated shaft 110 with the second filter support device 125. When engaged, filter support retention device 135 limits displacement of second filter support device 125 relative to elongated shaft 110. In addition, filter support retention device 135 may provide force upon one or more of elongated shaft 110, first filter support device 120, and second filter support device 125 when cartridge filter 130 is installed upon apparatus 100, in a direction substantially longitudinal to elongated shaft 110. This force may cause an axial compressive force upon cartridge filter 130 when installed upon apparatus 100, and cause an axial tensile force upon elongated shaft 110.

In one embodiment, filter support retention device 135 is integrally connected to at least one of first filter support device 120 and second filter support device 125. One of ordinary skill will readily recognize that filter support retention device 135 may be any convenient device for readily and quickly engaging two components, including, but not limited to, a threaded nut, a clamp, and a pin.

With continued reference to FIG. 1, apparatus 100 further includes a latch device 140. Latch device 140 is configured to selectively engage at least a portion of elongated shaft 110 and limit displacement of elongated shaft 110 relative to first mounting member 105. One of ordinary skill will readily recognize that latch device 140 may be any device for fastening and releasing two components, including, but not limited to, a latch, a hook, a clip, a pin, a magnet, and a strap. In one embodiment, the latch device 140 is operatively connected to first mounting member 105. In another embodiment, the apparatus 100 further includes a second mounting member 145, in which case latch device 140 may be operatively connected to second mounting member 145.

Second mounting member 145 may be of any arrangement sufficient to provide a stable mounting base for latch device 140. In one example embodiment, first mounting member 105 and second mounting member 145 are spaced apart by approximately length L of elongated shaft 110. In this embodiment, elongated shaft 110 is operatively connected to first mounting member 105 at its first end by joint device 115, and selectively attached to second mounting member 145 at its second end by latch device 140. In another example embodiment, latch device 140 may be integrally connected to joint device 115.

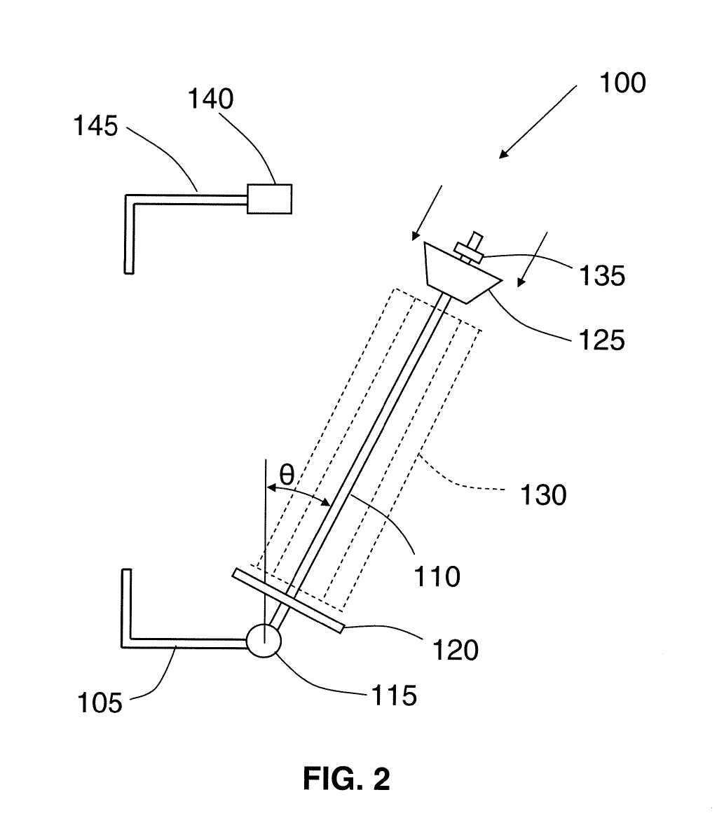

FIG. 2 illustrates one embodiment of the apparatus 100 of FIG. 1 in an open position. In this embodiment, joint device 115 permits elongated shaft 110 to tilt an angular displacement θ to permit clearance of second mounting member 145 and latch device 140. A cartridge filter 130 can then be installed over elongated shaft 110 and supported at its first end by first filter support device 120. Filter support retention device 135 is then installed onto elongated shaft 110 and engaged with elongated shaft 110 and second filter support device 125. Elongated shaft 110 may then be tilted back into the position illustrated in FIG. 1 (i.e., at an angular displacement of)0° to permit at least a portion of the elongated shaft to selectively engage latch device 140. When the latch device 140 is engaged, apparatus 100 is configured to substantially prevent displacement of the cartridge filter 130. Cartridge filter 130 may then be cleaned using known methods as will be readily recognized by one of ordinary skill, including, but not limited to: directing a stream of a liquid (e.g., water) onto the cartridge filter, directing a stream of a gas (e.g., air) onto the cartridge filter, and wiping or brushing the cartridge filter with a cleaning device such as a sponge, rag, or brush.

FIG. 3 illustrates another example embodiment of an apparatus 300 for securing a filter. Apparatus 300 is substantially the same as the apparatus 100 illustrated in FIG. 1, except for the differences described herein. Like components are referred to by like reference numerals.

In this example embodiment, the first mounting member 105 is operatively connected to the second mounting member 145 by a bracket 305. Bracket 305 may be of any arrangement sufficient to provide a stable mounting base to which first mounting member 105 and second mounting member 145 may be operatively connected. Bracket 305 may be configured to allow for mechanical attachment to another structure (e.g., a wall, a pole, a fence post, or a vehicle).

With continued reference to FIG. 3, apparatus 300 includes a first filter support device 310 that is of a similar shape as second filter support device 125. In one known embodiment, first filter support device 310 and second filter support device 125 are configured to translate in an axial direction along elongated shaft 110. As depicted in FIG. 3, apparatus 300 further includes a multitude of filter support retention devices 135 configured to selectively engage elongated shaft 110 with the filter support devices 310, 125. When engaged, filter support retention devices 135 limit displacement of the filter support devices 310, 125 relative to the elongated shaft 110. One of ordinary skill will readily recognize that first and second filter support devices 310, 125 may be any combination of any shapes as described above with respect to FIG. 1.

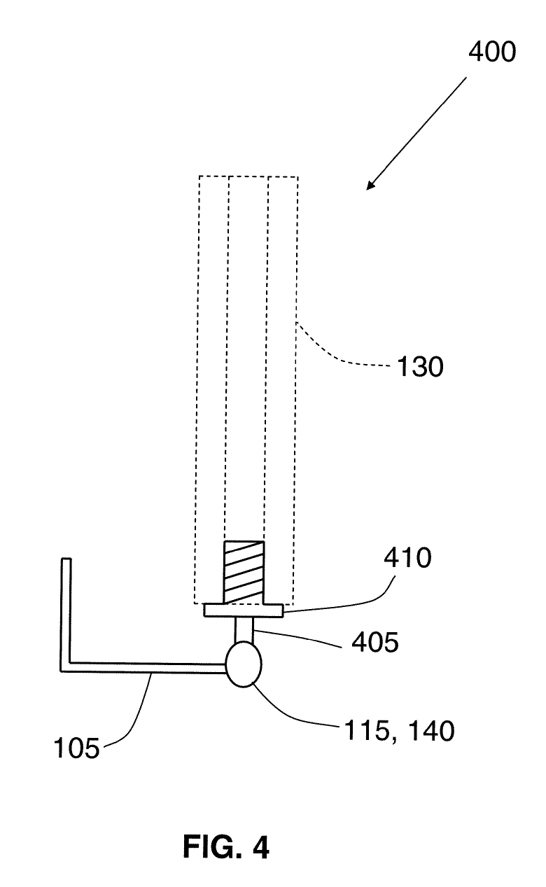

FIG. 4 illustrates another embodiment of an apparatus 400. Apparatus 400 is substantially the same as the apparatus 100 illustrated in FIG. 1, except for the differences described herein. Apparatus 400 includes a first mounting member 105 and an elongated shaft 405. At least a first portion of elongated shaft 405 is operatively connected to first mounting member 105 by a joint device 115, and at least a second portion of the elongated shaft is selectively engaged to first mounting member 105 by a latch device 140. At least a first filter support device 410 is operatively connected to elongated shaft 405. In this example embodiment, elongated shaft 405 is shorter than shown in other embodiments and does not extend through the cartridge filter. Instead, at least a portion of first filter support device 410 is threaded to engage a cartridge filter 130 having corresponding threads.

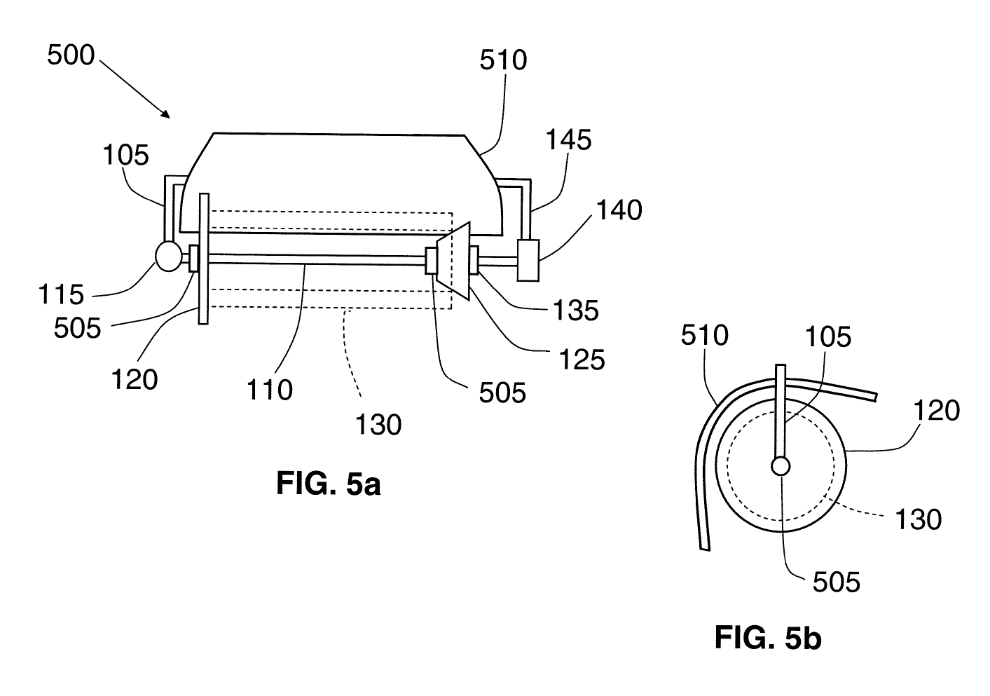

FIG. 5a illustrates yet another embodiment of an apparatus 500. Apparatus 500 is substantially the same as the apparatus 100 illustrated in FIG. 1, except for the differences described herein. At least one bearing device 505 is operatively connected to first filter support device 120 and second filter support device 125. In an alternative embodiment (not shown), bearing device 505 is operatively connected to first filter support device 120 instead of second filter support device 125. In another alternative embodiment (not shown), bearing device 505 is operatively connected to second filter support device 125 instead of first filter device 120.

Bearing device 505 permits rotation of first filter support device 120 and second filter support device 125 about an axis substantially parallel to elongated shaft 110 in a single direction. When a cartridge filter 130 is installed over elongated shaft 110 and engaged by first filter support device 120 and second filter support device 125, as fully described above with regard to FIG. 2, bearing device 505 permits cartridge filter 130 to rotate about the elongated shaft. In one embedment, rotation is limited to a single direction, which may be desirable when using known cleaning methods, such as directing a stream of liquid (e.g., water) or a stream of gas (e.g., air) onto cartridge filter 130, to ensure adequate cleaning of a first side of the filter ribs. Cartridge filter 130 may then be removed from apparatus 500 and installed in the opposite direction to facilitate adequate cleaning of a second side of the filter ribs.

With continued reference to FIG. 5a, and with further reference to FIG. 5b, apparatus 500 includes a barrier device 510. In one embodiment, barrier device 510 is configured with a sufficient size, shape, and contour to intercept foreign materials and/or water or air discharged from cartridge filter 130 during the cleaning of the cartridge filter. In one embodiment, barrier device 510 may include a curved contour and extend approximately 90-270 degrees around cartridge filter 130. In another embodiment, barrier device 510 may extend approximately 135-180 degrees around cartridge filter 130.

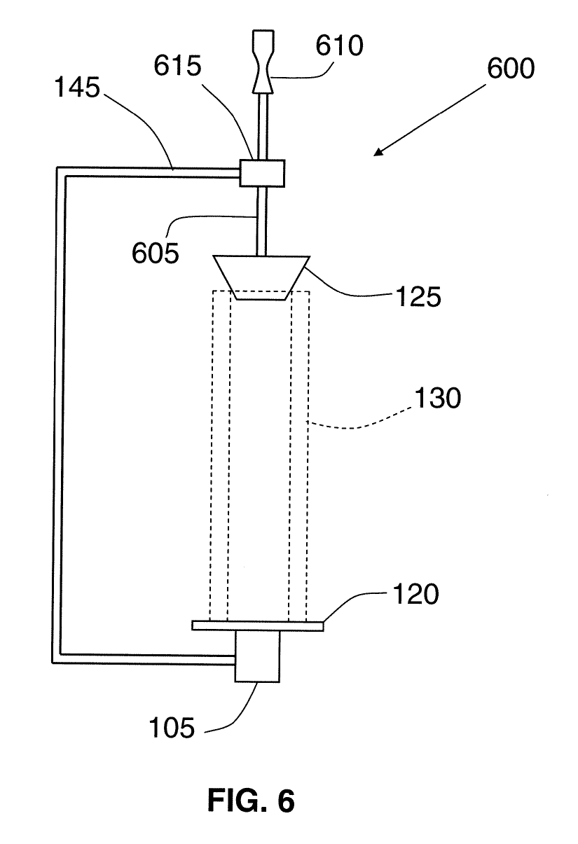

FIG. 6 illustrates another embodiment of an apparatus 600. Apparatus 600 is substantially the same as the apparatus 100 illustrated in FIG. 1, except for the differences described herein. Apparatus 600 includes a first filter support device 120 operatively connected to a first mounting member 105. Apparatus 600 additionally includes an elongated shaft 605 operatively connected to a second mounting member 145. A second filter support device 125 is operatively connected to elongated shaft 605. Elongated shaft 605 is shorter than the elongated shafts shown in FIGS. 1-3, 5a, and 5b, and does not extend through the cartridge filter 130. One of ordinary skill will readily recognize that first and second filter support devices 120, 125 may be any combination of shapes as described above with respect to FIG. 1. In this example embodiment, a handle 610 is operatively connected to elongated shaft 605.

As depicted in FIG. 6, apparatus 600 may further include an elongated shaft retention device 615 configured to selectively engage elongated shaft 605 with second mounting member 145. When engaged, elongated shaft retention device 615 limits displacement of elongated shaft 605 relative to second mounting member 145. In addition, elongated shaft retention device 615 may provide force upon one or more of elongated shaft 605, second filter support device 125, and second mounting member 145 when cartridge filter 130 is installed upon apparatus 600, in at least a direction substantially longitudinal to elongated shaft 605. Engagement of elongated shaft retention device 615 when cartridge filter 130 is installed onto apparatus 600 and engaged by at least first filter support device 120 and second filter support device 125 prevents substantial displacement of cartridge filter 130 relative to elongated shaft 605. In one example embodiment, this force causes at least an axial compressive force upon elongated shaft 605 and cartridge filter 130 when installed upon apparatus 600.

In one embodiment, elongated shaft retention device 615 is integrally connected to second mounting member 145. One of ordinary skill will readily recognize that elongated shaft retention device 615 may be any convenient device for readily and quickly engaging two components, including, but not limited to, a threaded nut, a clamp, and a pin.

In one embodiment, the apparatuses 100, 200, 300, 400, 500, and 600 as described above are configured to prevent displacement of cartridge filter 130 during application of a pressurized liquid to the cartridge filter, wherein the pressurized liquid may have a pressure of up to about 3000 psi. In another embodiment, the apparatuses 100, 200, 300, 400, 500, and 600 are configured to prevent displacement of cartridge filter 130 during application of a pressurized gas to the cartridge filter, wherein the pressurized gas may have a pressure of up to about 200 psi.

While the systems, methods, and so on have been illustrated by describing examples, and while the examples have been described in considerable detail, it is not the intention of the applicant to restrict, or in any way, limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

Finally, to the extent that the term “includes” or “including” or “having” is employed in the detailed description or the claims, it is intended to be inclusive in a manner similar to the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modern Legal Usage 624 (2d. Ed. 1995).

What is claimed:

1. An apparatus, comprising:
a first mounting member;
a second mounting member;
a first filter support device and a second filter support device, wherein at least a portion of the first filter support device and second filter support device is configured to selectively engage at least a first end portion and a second end portion of a cartridge filter;
an elongated shaft, wherein at least a portion of the elongated shaft is operatively connected to each of the second mounting member and the second filter support device; and
a handle operatively connected to the elongated shaft.

2. The apparatus of claim 1, wherein at least a portion of the elongated shaft comprises at least one of: threads, substantially transverse ribs, indentations, and substantially transverse perforations.

3. The apparatus of claim 1, further comprising an elongated shaft retention device configured to selectively engage the elongated shaft with the second mounting member, wherein the elongated shaft retention device prevents substantial displacement of the elongated shaft relative to the second mounting member.

4. The apparatus of claim 3, wherein the elongated shaft retention device is integrally connected to the second mounting member.

5. The apparatus of claim 3, wherein the elongated shaft retention device comprises at least one of: a nut, a clamp, and a pin.

6. The apparatus of claim 1, wherein at least a portion of at least one of the first filter support device and second filter support device is configured to selectively engage an inner surface of a filter.

7. The apparatus of claim 1, wherein at least one of the first filter support device and second filter support device is a frustum configured to selectively engage an inner surface of a cartridge filter.

8. The apparatus of claim 1, wherein at least one of the first mounting member and second mounting member is configured to be attached to a structure.

9. An apparatus, comprising:
a handle;
a first mounting member;
a second mounting member;
a first filter support device;
a second filter support device; and
an elongated shaft, wherein at least a portion of the elongated shaft is operatively connected to the second mounting member, the second filter support device, and the handle.

10. The apparatus of claim 9, wherein at least a portion of the elongated shaft comprises at least one of: threads, substantially transverse ribs, indentations, and substantially transverse perforations.

11. The apparatus of claim 9, further comprising an elongated shaft retention device configured to selectively engage the elongated shaft with the second mounting member, wherein the elongated shaft retention device prevents substantial displacement of the elongated shaft relative to the second mounting member.

12. The apparatus of claim 11, wherein the elongated shaft retention device is integrally connected to the second mounting member.

13. The apparatus of claim 11, wherein the elongated shaft retention device comprises at least one of: a nut, a clamp, and a pin.

14. The apparatus of claim 9, wherein at least a portion of at least one of the first filter support device and second filter support device is configured to selectively engage at least one of a first end portion and a second end portion of a cartridge filter.

15. An apparatus, comprising:
a first mounting member;
a first filter support device;
a second filter support device;
an elongated shaft, wherein at least a portion of the elongated shaft is operatively connected to the first mounting member by a joint device, the first filter support device, and the second filter support device; and
at least one filter support retention device configured to selectively engage the elongated shaft with the second filter support device, wherein the at least one filter support retention device prevents substantial displacement of the second filter support device relative to the elongated shaft.

16. The apparatus of claim 15, wherein at least a portion of the elongated shaft comprises at least one of: threads, substantially transverse ribs, indentations, and substantially transverse perforations.

17. The apparatus of claim 15, wherein the joint device permits angular displacement of the elongated shaft about at least one axis substantially transverse to the elongated shaft, and wherein the joint device comprises at least one of: a hinge, a ball and socket, and a slide.

18. The apparatus of claim 15, wherein the filter support retention device comprises at least one of: a nut, a clamp, and a pin.

19. The apparatus of claim 15, further comprising:
a latch device configured to selectively engage at least a portion of the elongated shaft, wherein the latch device comprises at least one of: a latch, a hook, a clip, a pin, a magnet, and a strap.

20. The apparatus of claim 19, further comprising:
a second mounting member, wherein the latch device is operatively connected to the second mounting member.
